(19) United States
(12) Patent Application Publication
(10) Pub. No.: US 2003/0228488 A1
(43) Pub. Date: Dec. 11, 2003

(54) Magnetic read head using (FePt)100-xCux as a permanent magnet material

(75) Inventors: Mark William Covington, Pittsburgh, PA (US); Michael Kevin Minor, Gibsonia, PA (US); Michael Allen Seigler, Pittsburgh, PA (US)

Correspondence Address: Bryan H. Opalko, Esquire, Buchanan Ingersoll, P.C., One Oxford Centre, 20th Floor, 301 Grant Street, Pittsburgh, PA, 15219, US

(73) Assignee: Seagate Technology LLC, Scotts Valley, CA

(21) Appl. No.: 10/388,917

(22) Filed: Mar. 14, 2003

Related U.S. Application Data
(60) Provisional application No. 60/386,531, filed on Jun. 5, 2002.

(51) Int. Cl. B32B 9/00

(52) U.S. Cl. 428/692; 428/694 R

(57) ABSTRACT

A magnetic structure including a first layer of hard magnetic material which has a magnetization that is substantially fixed in a first magnetization direction, a second layer of ferromagnetic material which has a magnetization that it is substantially rotatable, a nonmagnetic layer provided between the first hard magnetic and second ferromagnetic layers, and a hard magnetic material element which has a magnetization that is substantially fixed in a second magnetization direction. The hard magnetic material element is magnetically coupled to the second ferromagnetic layer and biases the second ferromagnetic layer such that its magnetization is biased to lie in the second magnetization direction. Either the first hard magnetic layer or the hard magnetic material element includes an FePtCu alloy. In one form, the FePtCu alloy includes the alloy (FePt)₁₀₀₋ₓCuₓ and, in a further form, the variable x is equal to five.

### CROSS-REFERENCE TO RELATED APPLICATIONS

This application claims the benefit of co-pending provisional patent application Serial No. 60/386,531 entitled “(FePt)₁₋ₓCuₓ as a Permanent Magnet Material for Magnetic Recording Heads”, filed on Jun. 5, 2002, the entire disclosure of which is incorporated by reference herein.

### FIELD OF THE INVENTION

The present invention is directed toward magnetic devices and, more particularly, toward magnetic devices utilizing an FePtCu alloy as a permanent magnetic material.

### BACKGROUND OF THE INVENTION

Magnetic recording heads used in hard disc drives typically have separate reader and writer components which are merged onto the same recording head. Magnetic readers are passive devices that detect the stray magnetic fields originating from the local magnetic domains, or bits, formed in a magnetic recording media on the surface of a magnetic recording disc. Conventional magnetic readers detect these fields by detecting changes in the magnetoresistance of a thin film multilayer structure that contains ferromagnetic materials, as the multilayer structure is passed over the local magnetic domains. In order for magnetic readers to operate properly, they require permanent magnetic materials to properly bias and stabilize the ferromagnetic materials.

One type of magnetic read head typically utilized in magnetic recording heads is a spin valve device. The heart of conventional spin valve readers consists of a pinned ferromagnetic layer having a nominally fixed magnetization and a free ferromagnetic layer having a substantially rotatable magnetization. The pinned layer (PL) provides a fixed reference as the free layer (FL) magnetization rotates in response to the fields from the recording media as the spin valve read head passes over the media. The magnetoresistance is a function of the relative orientation of the magnetization of the pinned and free layers, with an anti-parallel magnetic configuration exhibiting the highest resistance and a parallel magnetic configuration exhibiting the lowest resistance. The implementation of such a magnetic reader device can be accomplished in many different ways. However, two known implementations utilize permanent magnetic materials to either bias the magnetization of the free layer and to set the orientation of the pinned layer magnetization.

As the physical dimensions of the reader and writer in magnetic recording heads decrease in response to increases in areal density, the issues of biasing the free layer and setting the orientation of the pinned layer become more challenging. One problem that must be overcome is the thermal fluctuation of the magnetization of such small structures. Simple scaling of the physical dimensions of conventional reader designs leads to greater thermal fluctuations as the size of the reader is reduced. As a result, the pinned layer will need to incorporate materials having a large coercivity in order to maintain a fixed magnetic orientation throughout the operational lifetime of the reader. In some reader designs, such as the current-perpendicular-to the-plane (CPP) multilayer reader, a relatively large amount of magnetic flux is required in order to properly bias the reader. This bias field is a function of both the remanent moment and the geometry of the permanent magnetic and, thus, permanent magnetic materials having large remanent moments and coercivities are desirable in the construction of such magnetic readers.

It is also desirable to minimize the stray series resistance in CPP spin valve magnetic readers. Various pinning materials that have been optimized for current-in-plane (CIP) spin valve readers, such as the anti-ferromagnetic materials IrMn and PtMn, have large resisitivies that add a significant amount of resistance to a CPP spin valve reader. Thus, it is undesirable to use these materials to set the magnetic orientation of the pinned layer in CPP spin valve readers.

Whatever permanent magnetic materials are utilized in the magnetic read heads, they must be compatible with the overall wafer processing involved in the manufacturing of magnetic recording heads. Two preferred characteristics of permanent magnetic materials incorporated in magnetic read head designs are resistance to corrosion and the ability to be processed at or below temperatures of approximately 300° C. Thus, there is a need for permanent magnetic materials having large remanent moments and coercivities that can be readily incorporated into existing magnetic recording head technology and the processes for the manufacture thereof.

The present invention is directed toward overcoming one or more of the above-mentioned problems.

### SUMMARY OF THE INVENTION

A magnetic sensing structure is provided according to the present invention that is capable of being utilized in magnetic read head devices. However, the inventive structure is not limited to such use. Other uses may include, but are not limited to, use in magnetic random access memory (MRAM) cells and in magnetic field sensors, to name a few. The magnetic material structure includes a first layer of hard magnetic material which has a magnetization that is substantially fixed in a first magnetization direction, a second layer of ferromagnetic material which has a magnetization that is substantially rotatable, and a nonmagnetic layer provided between the first hard magnetic and second ferromagnetic layers. The first hard magnetic layer includes an FePtCu alloy. In one form, the FePtCu alloy includes the alloy (FePt)₁₀₀₋ₓCuₓ and, in a further form, the variable x is equal to five.

The magnetic sensing structure may include a third layer of ferromagnetic material provided between the nonmagnetic and first hard magnetic layers. The magnetization of the third ferromagnetic layer is biased by the first hard magnetic layer such that the magnetization of the third ferromagnetic layer lies in the first magnetization direction.

The magnetic sensing structure may additionally include a fourth layer of ferromagnetic material provided between the nonmagnetic and third ferromagnetic layers. This fourth ferromagnetic layer is anti-ferromagnetically coupled to the third ferromagnetic layer such that the magnetization of the fourth ferromagnetic layer lies in a direction that is substantially anti-parallel to the first magnetization direction. The anti-ferromagnetic coupling may be provided by a thin layer of ruthenium or other similar material disposed between the third and fourth ferromagnetic layers.

In an alternate embodiment of the present invention, a magnetic sensing structure is provided that includes a first layer of ferromagnetic material which has a magnetization that is substantially fixed in a first magnetization direction, a second layer of ferromagnetic material which has a magnetization that is substantially rotatable, a nonmagnetic layer provided between the first and second ferromagnetic layers, and a hard magnetic material element which has a magnetization that is substantially fixed in a second magnetization direction. The hard magnetic material element is magnetically coupled to the second ferromagnetic layer and biases the second ferromagnetic layer such that the magnetization of the second ferromagnetic layer is biased to lie in the second magnetization direction. The hard magnetic material element includes an FePtCu alloy and, in one form, includes the alloy (FePt)₁₀₀₋ₓCuₓ. In a further form, the variable x is equal to five.

The alternate embodiment of the present invention may also include a third layer of ferromagnetic material provided between the nonmagnetic and first ferromagnetic layers, and a fourth layer of ferromagnetic material provided between the nonmagnetic and third ferromagnetic layers. The first ferromagnetic layer biases the magnetization of the third ferromagnetic layer such that the magnetization of the third ferromagnetic layer lies in the-first magnetization direction. The fourth ferromagnetic layer is anti-ferromagnetically coupled to the third ferromagnetic layer such that the magnetization of the fourth ferromagnetic layer is in a direction that is substantially anti-parallel to the first magnetization direction.

The hard magnetic material element may include spaced apart first and second hard magnetic material elements. The first and second hard magnetic material elements may be disposed adjacent opposite edges of the first ferromagnetic, second ferromagnetic and nonmagnetic layers, or may be disposed on top of the first ferromagnetic layer.

A magnetic sensing structure is also provided according to a further embodiment of the present invention. This further embodiment of the magnetic sensing structure includes a plurality of intermixed layers of ferromagnetic and nonmagnetic materials, and a hard magnetic material element disposed adjacent to a thin nonmagnetic insulator that is adjacent an edge of the plurality of intermixed layers. The layers of ferromagnetic material provided within the intermixed layers each have a magnetization direction that is substantially rotatable. The hard magnetic material element includes an FePtCu alloy and biases the magnetization directions of the ferromagnetic layers. In one form, the FePtCu alloy includes the alloy (FePt)₁₀₀₋ₓCuₓ and, in a further form, the variable x is equal to five.

A magnetic sensing structure is provided according to yet a further embodiment of the present invention, and includes a first layer of hard magnetic material which has a magnetization that is substantially fixed in a first magnetization direction, a second layer of ferromagnetic material which has a magnetization that it is substantially rotatable, a nonmagnetic layer provided between the first hard magnetic and second ferromagnetic layers, and a hard magnetic material element which has a magnetization that is substantially fixed in a second magnetization direction. The hard magnetic material element is magnetically coupled to the second ferromagnetic layer and biases the second ferromagnetic layer such that its magnetization is biased to lie in the second magnetization direction. Either the first hard magnetic layer or the hard magnetic material element includes an FePtCu alloy. In one form, the FePtCu alloy includes the alloy (FePt)₁₀₀₋ₓCuₓ and, in a further form, the variable x is equal to five.

The magnetic sensing structure according to the various embodiments of the present invention may be utilized in various magnetic sensing devices including, but not limited to, current-in-plane, current-perpendicular-to-the-plane, tunnel junction, spin valve, magnetoresistive and giant magnetoresistive magnetic read heads. Depending upon the type of magnetic read head in which the magnetic sensing structure is utilized, the nonmagnetic layer may include either a layer of metallic material or a layer of insulating material.

It is an aspect of the present invention to provide a permanent magnetic material for use in magnetic sensing devices having a large coercivity and capable of being processed at or below temperatures of approximately 300° C.

It is a further aspect of the present invention to provide a permanent magnetic material for use in magnetic sensing devices that will aid in suppressing thermal fluctuations in smallscale devices necessary for magnetic recording at areal densities around 1 Tbit/in².

It is an additional aspect of the present invention to provide pinning and permanent magnet materials for use in magnetic sensing devices that have large coercivities and that can be readily incorporated into existing magnetic recording head technologies.

Other aspects and advantages of the present invention can be obtained from a study of the specification, the drawings, and the appended claims.

### BRIEF DESCRIPTION OF THE DRAWINGS

FIG. 1 is an air bearing surface view of a current-in-plane (CIP) spin valve magnetic reader incorporating the inventive magnetic sensing structure;

FIG. 2 an air bearing surface view of a tunnel junction magnetic reader incorporating the inventive magnetic sensing structure;

FIG. 3 is a partial side view of a current-perpendicular-to-the-plane (CPP) multilayer giant magnetoresistive (GMR) magnetic reader incorporating the inventive magnetic sensing structure;

FIG. 4 is a partial perspective view of the magnetic sensing structure according to the present invention;

FIG. 5 is a partial perspective view of the magnetic sensing structure according to an alternate embodiment of the present invention;

FIG. 6 is a partial perspective view of the magnetic sensing structure according to a further embodiment of the present invention;

FIG. 7 shows the in-plane magnetization of a 1000 Å thick FePtCu film after an anneal at 300° C. for 4 hours;

FIG. 8 shows the coercivity of a 1000 Å thick FePtCu film as function of annealing time at 300° C.;

FIG. 9 shows in the in-plane magnetization of FePtCu films of varying thicknesses after anneal at 300° C. for 1 hour;

FIG. 10 shows the normalized in-plane magnetization for a 1000 Å thick film of (FePt)₉₅Cu₅ that has been annealed and subsequently etched in an ion mill to varying thicknesses; and

FIG. 11 shows the normalized in-plane magnetization of a 200 Å thick FePtCu film utilizing different buffer layers.

### DETAILED DESCRIPTION OF THE INVENTION

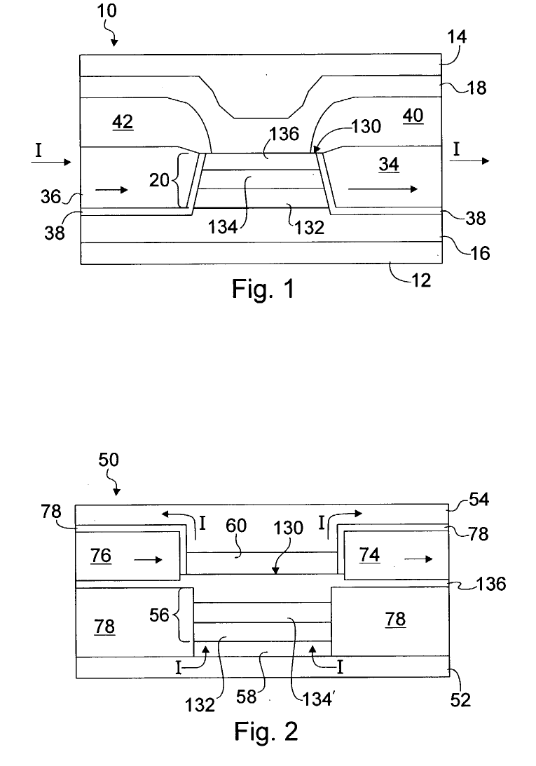

FIG. 1 illustrates an air bearing surface view of a CIP spin valve reader, shown generally at 10. The reader 10 includes shield layers 12 and 14 made of a permalloy material, such as NiFe and the like. Gap layers 16 and 18 of aluminum-oxide (Al₂O₃), or other similar material, are provided adjacent the shield layers 12 and 14, respectively. A multilayer magnetic sensing structure 20 is provided between the gap layers 16 and 18. The multilayer magnetic sensing structure 20 includes a magnetic sensing structure 130 having, in order, a layer of hard magnetic material 132, a layer of nonmagnetic material 134, and a layer of ferromagnetic material 136. Permanent magnets 34 and 36 are provided on top of the gap layer 16 and are disposed adjacent opposite edges of the multilayer magnetic sensing structure 20. The permanent magnets 34 and 36 are separated from the gap layer 16 and the multilayer magnetic sensing structure 20 by a thin layer of nonmagnetic material 38. Contact layers 40 and 42 of gold (Au) or other similar material are provided on top of the permanent magnets 34 and 36, respectively, and are electrically connected to a current source (not shown).

The hard magnetic material layer 132 is an FePtCu alloy provided as a pinned layer and includes a magnetization that is fixed in a first magnetization direction. The ferromagnetic material layer 136 is provided as a free layer and includes a magnetization that is substantially rotatable. The nonmagnetic material layer 134 separating the pinned layer 132 and the free layer 136 includes a layer of metallic material, typically copper, however, other metallic materials may be utilized without departing from the spirit and scope of the present invention.

In operation, a voltage source (not shown) is connected to the contacts 40 and 42 and a current is passed through the contacts 40 and 42, permanent magnets 34 and 36 and multilayer magnetic sensing structure 20 in the direction shown. As the reader 10 is passed over the local magnetic domains on the surface of a magnetic recording disc, the magnetization of the free layer 136 rotates in response to the magnetic fields originating from the local magnetic domains. The magnetoresistance of the multilayer magnetic sensing structure 20 is a function of the relative orientation of the magnetization of the free layer 136 and the pinned layer 132. Thus, as the reader 10 is passed over these local magnetic domains, the changing magnetoresistance of the multilayer magnetic sensing structure 20 results in a change of current through the reader 10. This change in current is detected by a current detector (not shown) which detects the variations in current that are due to the changes in the magnetization direction of the free layer 136. In this manner, the reader 10 is able to read the information stored on the recording disc.

One skilled in the art will appreciate that instead of using a voltage source connected across the contacts 40 and 42 and measuring the current, the reader 10 may also operate by connecting a current source across the contacts 40 and 42 and sensing the change in voltage across the reader 10.

FIG. 2 illustrates an air bearing surface view of a tunnel junction magnetic reader, shown generally at 50. The reader 50 includes shield layers 52 and 54 of permalloy material, such as NiFe and the like. A multilayer magnetic sensing structure 56 is provided between the shield layers 52 and 54, and is separated from the shield layers 52 and 54 by layers of nonmagnetic metallic material 58 and 60, respectively. The metallic layers 58 and 60 may be made of copper or other similar material. The multilayer magnetic sensing structure 56 includes the magnetic sensing structure 130 having, in order, the layer of hard magnetic material 132, a layer of insulating material 134′, and the layer of ferromagnetic material 136. Permanent magnets 74 and 76 are provided directly on top of the ferromagnetic layer 136. The permanent magnets 74 and 76 bias the magnetization of the ferromagnetic layer 136 via exchange coupling. Gap layers 78 of aluminum-oxide (Al₂O₃) or similar material are provided between the ferromagnetic layer 136 and shield 52, and between the permanent magnets 74, 76 and shield 54. One skilled in the art will recognize that should the reader 50 include a CPP spin valve reader, the layer 134′ will include a metallic material such as Cu and the like.

The hard magnetic material layer 132 is an FePtCu alloy provided as a pinned layer and includes a magnetization that is fixed in a first magnetization direction. The ferromagnetic material layer 136 is provided as a free layer and includes a magnetization that is substantially rotatable. The magnetization of the free layer 136 is biased by the permanent magnets 74 and 76 to lie in the same direction of magnetization as that of the permanent magnets 74 and 76. However, as noted, the magnetization of the free layer 136 is rotatable.

As shown in FIG. 2, a current is passed through reader 50 in the direction shown by a conventional voltage source (not shown) connected to the reader 50. As the reader 50 is passed over the local magnetic domains of a magnetic recording disc, the stray magnetic fields originating therefrom rotate the magnetic field of the free layer 136. This rotation causes a change in the magnetoresistance of the multilayer magnetic sensing structure 56. This change in magnetoresistance produces a change in current through the reader 50, which is detected by a current detector (not shown). In this manner, the reader 50 is able to read the information stored on the recording disc.

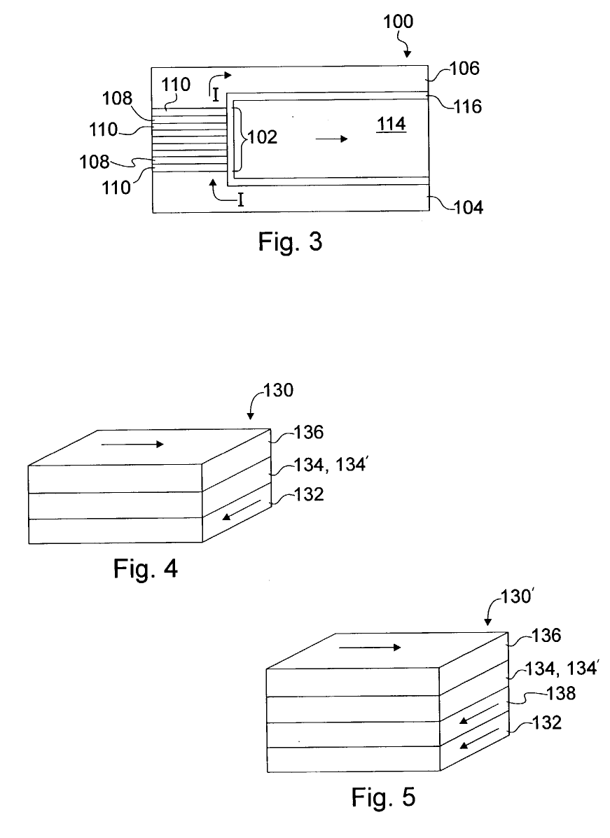

FIG. 3 illustrates a side view of a CPP multilayer GMR magnetic reader, shown generally at 100. The reader 100 includes a multilayer magnetic sensing structure 102 provided between shield layers 104 and 106 of permalloy material, such as NiFe and the like. The multilayer magnetic sensing structure 102 includes a plurality of intermixed and/or alternating layers of ferromagnetic 108 and nonmagnetic 110 materials. The layers 108 and 110 may have the same thicknesses, or may have varying thicknesses depending upon the particular application. A permanent magnet 114 made of an FePtCu alloy is provided behind the multilayer magnetic sensing structure 102, and is separated from the structure 102 and the shields 104 and 106 by a gap layer 116 of aluminum-oxide (Al₂O₃) or other similar material.

The FePtCu permanent magnet 114 biases the magnetization directions of the ferromagnetic layers 108, with each of the ferromagnetic layers 108 having a magnetization that is substantially rotatable. A current is applied to the reader 100 in the direction shown by a voltage source (not shown). As the reader 100 is passed over the local magnetic domains on a magnetic recording disc, these magnetic domains cause the magnetizations of the ferromagnetic layers 108 to rotate. The rotation of the magnetization of the ferromagnetic layers 108 changes the magnetoresistance of the multilayer magnetic sensing structure 102 and, hence, the current flowing therethrough. A current detector (not shown) detects the change in current caused by the changing magnetoresistance of the multilayer magnetic sensing structure 102. In this manner, the reader 100 is able to read the information stored on the recording disc.

The present invention is directed toward using an FePtCu alloy and, specifically, (FePt)₁₀₀₋ₓCuₓ, as either a pinning material or as a permanent magnetic material for magnetic recording heads. The addition of Cu to FePt reduces the ordering temperature required to produce the L1₀ phase. Specifically, the addition of small concentrations of Cu to FePt promotes ordering into the L1₀ phase after annealing at temperatures of only approximately 300° C. This temperature is now in a range that is useful for magnetic recording head fabrication. The FePtCu alloy contemplated herein may be utilized as a pinning material to set the magnetization direction of the pinned layer 132, or as a permanent magnet to bias the magnetization of the free layer 136. When used as a permanent magnet, the FePtCu alloy contemplated herein would be utilized as the material for the permanent magnets 34 and 36 in FIG. 1, 74 and 76 in FIG. 2, and 114 in FIG. 3. FIGS. 4-6 illustrate the use of an FePtCu alloy as a pinning material to set, or pin, the magnetization direction of the pinned layer 132.

FIG. 4 illustrates the magnetic sensing structure according to a first embodiment of the present invention, shown generally 130. The magnetic sensing structure 130 is utilized as the multilayer magnetic sensing structures 20 and 56 shown in FIGS. 1 and 2, respectively. The magnetic sensing structure 130 includes the layer of hard magnetic material 132 provided as a pinned layer. The nonmagnetic layer 134, 134′ is provided on top of the hard magnetic material layer 132. The nonmagnetic layer 134, 134′ may either be a layer of metallic material 134, such as copper and the like, or may be a layer of insulating material 134′ depending upon whether the magnetic sensing structure 130 is to be utilized as the multilayer magnetic sensing structure 20 in FIG. 1 or the multilayer magnetic sensing structure 56 in FIG. 2. The free layer of ferromagnetic material 136 is provided on top of the nonmagnetic layer 134. The hard magnetic material layer 132 includes the alloy (FePt)₁₀₀₋ₓCuₓ. The magnetization of the hard magnetic material layer 132 is fixed in the direction shown by its respective arrow. The free layer 136 has a magnetization that is biased in the direction shown by its respective arrow, but its magnetization is substantially rotatable. Operation of the magnetic sensing structure 130 is the same as previously described with respect to FIGS. 1 and 2. As the structure 130 is passed over the local magnetic domains on the disc surface, the magnetization of the free layer 136 rotates in response to the stray magnetic fields causing a change in the magnetoresistance of the structure 130 and, hence, in the current flowing therethrough. This change in current is detected by a conventional current detector (not shown) enabling information to be read from the recording disc.

A magnetic sensing structure according to a second embodiment of the present invention is illustrated in FIG. 5, shown generally at 130′. The magnetic sensing structure 130′ can be utilized as the multilayer magnetic sensing structures 20 and 56 shown in FIGS. 1 and 2, respectively. The magnetic sensing structure 130′ includes the addition of a pinned layer 138 of soft ferromagnetic material provided between the hard magnetic material layer 132 and nonmagnetic material layer 134, 134′. The hard magnetic material layer 132 is made of the (FePt)₁₀₀₋ₓCuₓ alloy and sets the magnetization direction of the pinned layer 138 in substantially the same direction as the magnetization of the hard magnetic material layer 132, as shown by their respective arrows in FIG. 5. Again, the magnetization of the free layer 136 is biased in the direction shown by its respective arrow, but is substantially rotatable. As the structure 130′ is passed over the local magnetic domains on the disc surface, the magnetization of the free layer 136 rotates in response to the stray magnetic fields. The magnetoresistance of the structure 130′ changes as a result of the rotation of the magnetization of the free layer 136, which in turn changes the current flowing therethrough. This change in current is detected by a conventional current detector (not shown) enabling information to be read off of the recording disc.

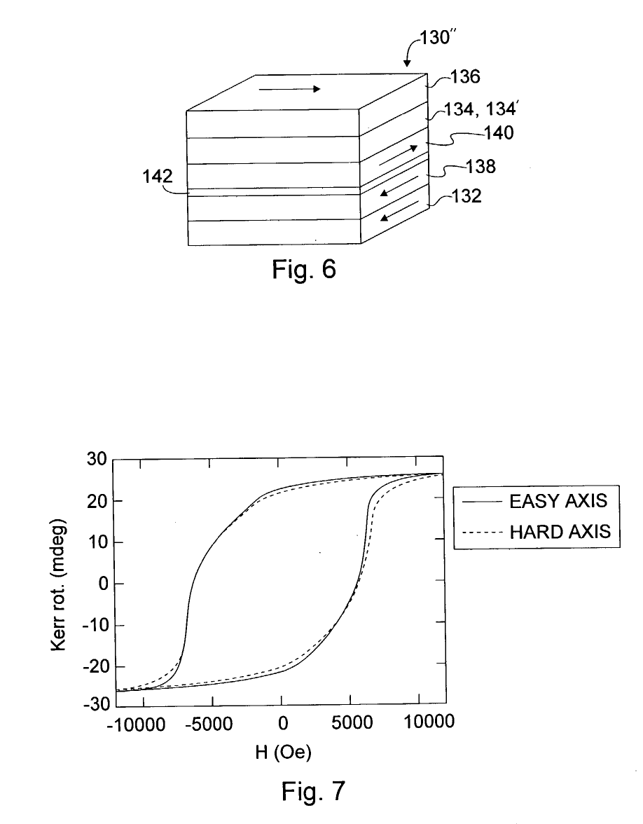

A magnetic sensing structure according to a third embodiment of the present invention is illustrated in FIG. 6, shown generally at 130″. The magnetic sensing structure 130″ can be utilized as the multilayer magnetic sensing structures 20 and 56 shown in FIGS. 1 and 2, respectively. The magnetic sensing structure 130″ includes the addition of a reference layer of ferromagnetic material 140 and a layer of ruthenium 142, with the layers 140 and 142 provided between the nonmagnetic material layer 134, 134′ and the pinned layer 138. The ruthenium layer 142 anti-ferromagentically couples the reference layer 140 to the pinned layer 138, such that the magnetization of the reference layer 140 is set in a direction that is substantially anti-parallel to the magnetization direction of the pinned layer 138 as shown by their respective arrows in FIG. 6. Again, the magnetization of the free layer 136 is biased in the direction shown by its respective arrow, but is substantially rotatable. As the magnetic sensing structure 130″ is passed over the local magnetic domains on the disc surface, the stray magnetic fields cause the magnetization of the free layer 136 to rotate. This rotation of the magnetization of the free layer 136 changes the magnetoresistance of the magnetic sensing structure 130″ and, hence, changes the current flowing therethough. This change in current is detected by a conventional current detector (not shown) enabling information to be read off of the recording disc.

While the deposition of FePtCu onto a room temperature substrate typically results in a disordered fcc (face centered cubic) phase with (111)-oriented texture, the fcc phase orders into the L1₀ phase upon anneal in much the same manner as the L1₀ anti-ferromagnetic materials PtMn and NiMn typically used for the anti-ferromagnetic layers utilized in spin valve and tunnel junction magnetic readers. Thus, FePtCu can be easily incorporated into the thin film multilayer structures (20 and 56) commonly used when building spin valve and tunnel junction magnetic readers. Application of FePtCu as a biasing source, i.e., as a permanent magnet, has even less constraints since the permanent magnet deposition is typically done separately from other manufacturing steps.

The use of the FePtCu alloy contemplated herein will satisfy many of the needs required to produce readers for high areal density recording. Foremost among these needs is thermal stability. Presented herein in FIGS. 7-11 are data obtained from the analyzation of FePtCu films. The data set forth in FIGS. 7-11 illustrate that it is possible to achieve high coercivities in FePtCu alloys. FePtCu films deposited on a variety of different buffer layers all develop a large coercivity after annealing. The data set forth in FIGS. 7-11 was obtained by analyzing an FePtCu alloy having the chemical structure (FePt)₁₀₀₋ₓCuₓ. Initially, data from the analyzed FePtCu films having the same thickness and undergoing the same anneal process indicate that the coercivity as a function of the Cu concentration exhibits a peak at approximately five atomic percent Cu, i.e., the variable x is equal to 5. However, it has been observed that the coercivity may peak for different concentrations of Cu, so the coercivity peak is likely process dependent. It is contemplated herein that the variable x in the alloy (FePt)₁₀₀₋ₓCuₓ, when used as a permanent magnetic material in magnetic read heads, may vary by plus or minus approximately one-percent (1.0%). The data set forth in FIGS. 7-11 was obtained through the analysis of an FePtCu alloy, namely, (FePt)₉₅Cu₅.

The magnetics of FePtCu films are largely isotropic, as shown in FIG. 7. An (FePt)₉₅Cu₅ thin film was deposited directly onto an SiO₂ substrate. FIG. 7 illustrates the in-plane magnetization of a 1000 Å thick FePtCu film after an anneal at 300° C. for 4 hours. The easy axis shown in FIG. 7 corresponds to a field sweep along the direction of the aligning field during deposition and the field applied during the anneal. The hard axis shown in FIG. 7 corresponds to a field sweep orthogonal to the easy axis. As shown in FIG. 7, the FePtCu film exhibits nearly isotropic behavior.

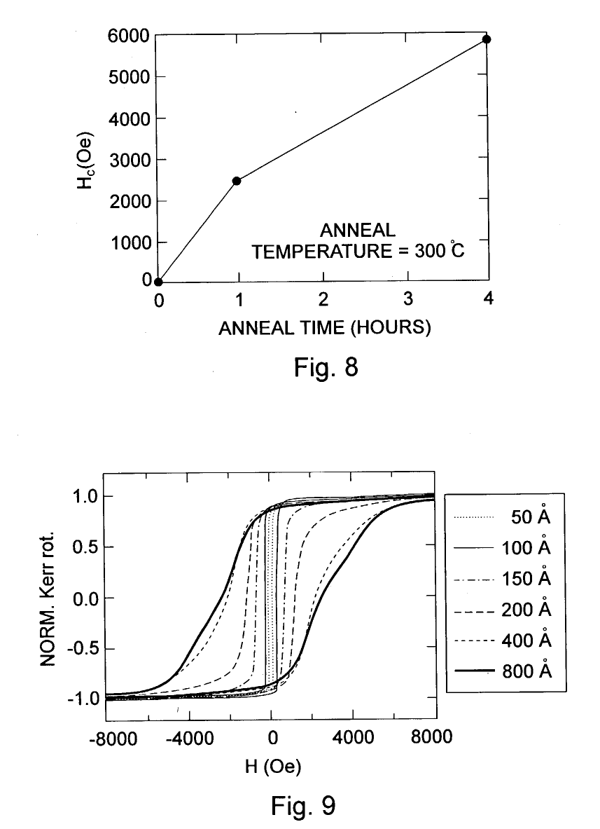

Additionally, the coercivity of FePtCu films is related to the degree of ordering into the L1₀ phase, which is driven by the time spent annealing at 300° C. FIG. 8 illustrates the resulting coercivity versus anneal time of a 1000 Å thick FePtCu film. As shown in FIG. 8, the coercivity of the FePtCu film increases the longer the time spent annealing.

Further, it has also been observed that (FePt)₉₅Cu₅ films deposited directly onto the SiO₂ substrate exhibit an increase in coercivity with an increase in the thickness of the deposited film. FIG. 9 illustrates the coercivity of FePtCu films of varying thickness that have been annealed for 1 hour at 300° C. As shown in FIG. 9, the coercivity of the FePtCu film increases by increasing the thickness of the as-deposited FePtCu film.

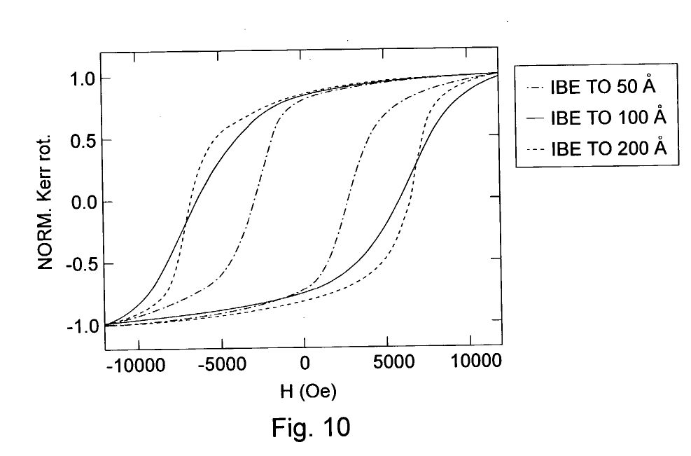

While the magnetic properties of FePtCu deposited on an SiO₂ substrate are good, there are additional ways to improve coercivity. First, it is has been found that thicker films develop a larger coercivity more easily than thinner films. Furthermore, once a high coercivity phase is formed, the FePtCu film can be etched and still maintain the large coercivity down to thicknesses of approximately 100-200 Å. FIG. 10 illustrates normalized in-plane magnetization data for a 1000 Å thick (FePt)₉₅Cu₅ film that was annealed and subsequently etched by conventional ion mill processes. As shown in FIG. 10, the FePtCu film maintains the large coercivity of the 1000 Å thick film (see FIG. 7) down to approximately 100-200 Å. Additionally, even the thinner 50 Å thick FePtCu film still exhibits a substantial coercivity of approximately 2800 Oe.

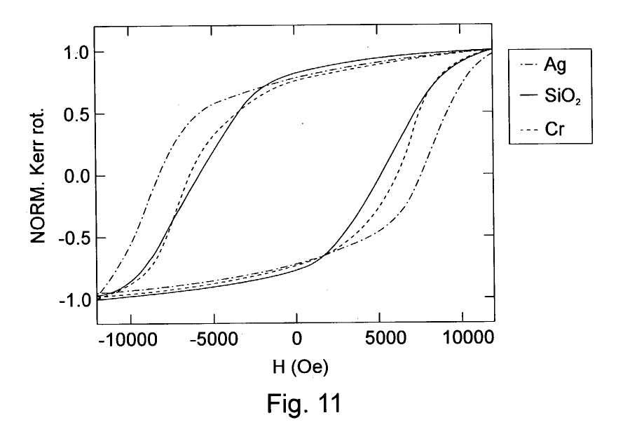

Further, it has also been shown that buffer layers can reduce the ordering temperature of pure FePt. The buffer layer should be such that it induces a strain in the FePt film that promotes the tetragonal distortion of the L1₀ phase. Enhancement of the coercivity of FePtCu films has been observed when using Ag and Cr buffer layers. However, it should be understood that many other buffer layers may produce the same effect. This coercivity enhancement is shown in FIG. 11, where the normalized in-plane magnetization data is observed for an FePtCu film deposited directly onto an SiO₂ substrate and using Ag and Cr as buffer layers. The FePtCu films analyzed in FIG. 11 were originally 1000 Å thick and subsequently annealed and etched down to 200 Å. The successful use of metallic buffer layers is also important for any application of an FePtCu film within a CPP multilayer structure, because this allows the CPP stack to be electrically connected to metallic leads at the top and bottom and a current to be passed through the CPP device.

The data provided in FIGS. 7-11 illustrate the advantages in the use of FePtCu films. FePtCu has the advantage that it will provide excellent thermal stability when used as a pinned layer in a spin valve type read head. It has been demonstrated that coercivities of approximately 5000 Oe can be readily achieved through the use of an FePtCu pinned layer. This is in contrast to other commonly used CoPt alloys that yield coercivities of only approximately 3000 Oe. Additionally, FePtCu has a larger remanent moment than most permanent magnet materials currently in use, allowing greater latitude for biasing. The coercivity of FePtCu is large for even relatively thick films, allowing it to be used as a permanent magnetic. In contrast, commonly used CoPt-based permanent magnet materials typically develop lower coercivities as the film thickness increases. While this can be circumvented by using appropriate buffer layers and/or by depositing a multilayer permanent magnetic structure, the use of a single layer of FePtCu greatly simplifies the manufacturing process.

Deposition of FePtCu onto a room temperature substrate (SiO₂) results in a disordered (111)-oriented fcc texture. This matches the growth texture of common spin valve and tunnel junction reader materials and allows FePtCu to be incorporated into the reader thin film multilayer stack. Additionally, FePtCu has a lower resistivity than currently used anti-ferromagnetic materials and other permanent magnet materials. A typical sheet resistance for a 200 Å thick (FePt)₉₅Cu₅ film is about 30 Ω per square, which corresponds to a resistivity of approximately 60 μΩ-cm. In contrast, the resistivity of commonly used IrMn is typically around 200 μΩ-cm. Thus, FePtCu has particular utility for CPP magnetic reader applications.

It has been shown herein that FePtCu can be made very thin and still exhibit a very large coercivity. This helps to reduce current shunting in CIP spin valve readers. Additionally, the large coercivity at thinner thicknesses also helps to minimize the shield-to-shield spacing and allows CIP magnetic readers to have thicker first and second halfgaps (16 and 18 in FIG. 1).

FePtCu films have various uses in magnetic reader devices. For example, FePtCu can be used as a hard magnetic pinning layer in CIP and CPP readers that require at least one layer with a fixed orientation of its magnetization. Such devices include, but are not limited to, GMR spin valve readers, magnetic tunnel junction readers, and write heads that control the pole tip magnetization via spin momentum transfer, e.g., a CPP write head. Additionally, FePtCu can be used as a permanent magnet for biasing read heads or spin momentum transfer based writers. FePtCu can also be used as a reference layer for biasing a CPP reader with spin momentum transfer. Very thin FePtCu films having large coercivities can be produced by depositing a thick film, annealing it, and then etching away the excess material. Further improvements can include using a process, such as gas cluster ion beam (GCIB) etching, to improve the surface smoothness before depositing additional layers on top of the FePtCu film.

The ordering of the FePtCu can be controlled by anneal temperature, Cu concentration, and through the use of appropriate buffer layers. The buffer layers should exhibit a lattice mismatch with respect to the FePt material that produces a strain that distorts the FePt lattice and favors the formation of the tetragonal distortion involved with the ordering into the L1₀ phase. Examples of buffer layers that promote such ordering of FePtCu include Ag and Cr. However, one skilled in the art will appreciate that other buffer layers may be utilized without departing from the spirit and scope of the present invention.

The annealing process can be done with or without a magnetic field. Since the annealed FePtCu exhibits nearly isotropic magnetic behavior, the anneal can be done with a field applied in an arbitrary direction. The FePtCu magnetization can then be reset into its final state at a later time. The coercivity of FePtCu films can be increased and its in-plane uniaxial anisotropy can be produced by depositing the FePtCu film on a buffer layer with in-plane texture, such as NiFeCr deposited at an oblique angle by ion beam deposition (IBD).

It has been shown herein that the addition of Cu to FePt can drive the ordering temperature of the high coercivity L1₀ phase into a range that is compatible with conventional magnetic recording head fabrication. FePtCu as a permanent magnetic material has many uses for pinning, biasing and stabilizing ferromagnetically based devices. The large coercivity exhibited by FePtCu will help suppress thermal fluctuations in the smallscale devices required for magnetic recording at areal densities of approximately 1 Tbit/in².

While the present invention has been described with particular reference to the drawings, it should be understood that various modifications could be made without departing from the spirit and scope of the present invention. For example, typically the dimensions of the inventive structure will be governed by its intended application, and such dimensions are readily ascertainable by one of ordinary skill in the art.

We claim:

1. A device comprising:
a first layer of hard magnetic material having a magnetization direction that is substantially fixed in a first magnetization direction, wherein the first hard magnetic layer comprises an FePtCu alloy;
a second layer of ferromagnetic material having a magnetization direction that is substantially rotatable; and
a nonmagnetic layer disposed between the first hard magnetic and second ferromagnetic layers.

2. The device of claim 1, further comprising:
a third layer of ferromagnetic material disposed between the nonmagnetic and first hard magnetic layers, wherein the first hard magnetic layer biases a magnetization direction of the third ferromagnetic layer in the first magnetization direction.

3. The device of claim 2, further comprising:
a fourth layer of ferromagnetic material disposed between the nonmagnetic and third ferromagnetic layers, wherein the fourth ferromagnetic layer is anti-ferromagnetically coupled to the third ferromagnetic layer such that a magnetization direction of the fourth ferromagnetic layer is substantially anti-parallel to the first magnetization direction.

4. The device of claim 1, wherein the fourth ferromagnetic layer is anti-ferromagnetically coupled to the third ferromagnetic layer by a layer of ruthenium provided between the third and fourth ferromagnetic layers.

5. The device of claim 1, wherein the device is selected from the group consisting of current-in-plane, current-perpendicular-to-the-plane, tunnel junction, spin valve, magnetoresistive and giant magnetoresistive magnetic read heads.

6. The device of claim 1, wherein the FePtCu alloy comprises (FePt)₁₀₀₋ₓCuₓ.

7. A device comprising:
a first layer of ferromagnetic material having a magnetization direction that is substantially fixed in a first magnetization direction;
a second layer of ferromagnetic material having a magnetization direction that is substantially rotatable;
a nonmagnetic layer disposed between the first and second ferromagnetic layers; and
a hard magnetic material element having a magnetization direction that is substantially fixed in a second magnetization direction, the hard magnetic material element magnetically coupled to the second ferromagnetic layer and biasing the second ferromagnetic layer in the second magnetization direction, wherein the hard magnetic material element comprises an FePtCu alloy.

8. The device of claim 7, further comprising:
a third layer of ferromagnetic material disposed between the nonmagnetic and first ferromagnetic layer, wherein the first ferromagnetic layer biases a magnetization direction of the third ferromagnetic layer in the first magnetization direction.

9. The device of claim 8, further comprising:
a fourth layer of ferromagnetic material disposed between the nonmagnetic and third ferromagnetic layers, wherein the fourth ferromagnetic layer is anti-ferromagnetically coupled to the third ferromagnetic layer such that a magnetization direction of the fourth ferromagnetic layer is substantially anti-parallel to the first magnetization direction.

10. The device of claim 7, wherein the FePtCu alloy comprises (FePt)₁₀₀₋ₓCuₓ.

11. The device of claim 7, wherein the device is selected from the group consisting of current-in-plane, current-perpendicular-to-the-plane, tunnel junction, spin valve, magnetoresistive and giant magnetoresistive magnetic read heads.

12. The device of claim 7, wherein the hard magnetic material element comprises first and second hard magnetic material elements diposed adjacent opposite edges of the first ferromagnetic, second ferromagnetic and nonmagnetic layers.

13. The device of claim 7, wherein the hard magnetic material element comprises spaced apart first and second hard magnetic material elements disposed on top of the second ferromagnetic layer.

14. A device comprising:
a plurality of intermixed layers of ferromagnetic and nonmagnetic materials, wherein the layers of ferromagnetic material have a magnetization direction that is substantially rotatable; and
a hard magnetic material element disposed adjacent an edge of the plurality of intermixed layers and biasing the magnetization directions of the ferromagnetic layers, wherein the hard magnetic material element comprises an FePtCu alloy.

15. The device of claim 14, wherein the FePtCu alloy comprises (FePt)₁₀₀₋ₓCuₓ.

16. The device of claim 14, wherein the device is selected from the group consisting of current-in-plane, current-perpendicular-to-the-plane, tunnel junction, spin valve, magnetoresistive and giant magnetoresistive magnetic read heads.

17. A magnetic reader having a magnetic sensing structure, the magnetic sensing structure comprising:
a first layer of hard magnetic material having a magnetization direction that is substantially fixed in a first magnetization direction;
a second layer of ferromagnetic material having a magnetization direction that is substantially rotatable;
a nonmagnetic layer disposed between the first hard magnetic and second ferromagnetic layers; and
a hard magnetic material element having a magnetization direction that is substantially fixed in a second magnetization direction, the hard magnetic material element magnetically coupled to the second ferromagnetic layer and biasing the second ferromagnetic layer in the second magnetization direction,
wherein either the first hard magnetic layer or the hard magnetic material element comprises an FePtCu alloy.

18. The magnetic reader of claim 17, wherein the FePtCu alloy of the first hard magnetic layer or the hard magnetic material element comprises (FePt)₁₀₀₋ₓCuₓ.

19. The magnetic reader of claim 18, wherein x equals 5.

20. The magnetic reader of claim 17, wherein the nonmagnetic material layer is selected from the group consisting of a metallic material and an insulating material.
